(19) United States
(12) Patent Application Publication
(10) Pub. No.: US 2008/0152264 A1
(43) Pub. Date: Jun. 26, 2008

(54) FLEXIBLE EASY-OPEN PACKAGE WITH RECLOSABLE FEATURE

(76) Inventors: Kenneth Charles Pokusa, Indian Head Park, IL (US); Jeffrey Thomas Weber, Lake Zurich, IL (US)

Correspondence Address: FITCH EVEN TABIN & FLANNERY, 120 S. LASALLE STREET, SUITE 1600, CHICAGO, IL, 60603-3406, US

(21) Appl. No.: 11/615,605

(22) Filed: Dec. 22, 2006

(51) Int. Cl. B65D 33/18; B31B 1/00; B65D 33/34

(52) U.S. Cl. 383/5; 383/86; 493/260

(57) ABSTRACT

A reclosable, flexible package for storing food products, the package including a pair of opposing panels connected via a bottom seal or fold, each having a flange opposite the bottom seal and a pair of end seals between the opposing panels that intersect the bottom seal. A pleat located in one of the panels, containing a tear strip for opening the package. A flange seal located between the flanges where one of the flanges extends beyond the flange seal to form a reclosure flap, removably secured to one panel by an adhesion surface to form a cover over the opening. Alternatively, the flanges are about equally aligned and sealed at the edges, with tear lines spaced from the edge to remove a portion of the flanges and flange seal when torn along a predetermined tear line, creating two flanges, one extending beyond the other to form a reclosure flap.

### FIELD

This disclosure relates generally to flexible food packaging, and more specifically to easy to open flexible food packages with reclosable features.

### BACKGROUND

One way of packaging food products is for the packaging to be constructed from a single web of material which wraps around the food product to be packaged and is sealed around it. To make this package, the ends of the web of film are brought together about the food product to make a longitudinal fin seal, which consists of sealing together the two ends of the same web of film and leaving a flap, or fin, along the center length of the package. Two transverse end seals seal the food product within the package.

Fin-seal packages often include an opening feature. Common opening features are tear strips which can be pulled to tear apart the package material at the top leaving exposed an opening. However, such packages containing only the tear strip typically do not provide a way to reclose the bag and if there is any unused product left inside of the bag it can either dry out or spoil, or additional storage containers may be found.

Another opening feature used is a peelable seal, such as a peelable fin seal. For example, two layers of the same web material can be peeled apart at the fin seal to gain access to the food product in the interior of the package. However, if a hermetically sealed package is required, then the fin seal must be made very durable such that it can securely hold the two fin layers together during shipping and storage of the package. If the same durable seal is also used as an opening means it may be difficult for the user to pull apart to open it. On the other hand, if the fin seal is made such that it is easy to open, then it will not be durable enough to function as a hermetic seal. Furthermore, trying to grasp the two thin layers of the fin seal with fingers and then peeling them apart may not be very easy to accomplish. Also, once the peel seal of the fins is separated it is not easy to reclose.

A reclosable feature is a zipper which can be used to both open the bag and serve as a reclosing device. A zipper may also have a peel seal just above or below the zipper and/or a tear strip for opening. An additional feature of the zipper opener is to provide a resealing or reclosing device once the package has been opened such that the food product inside the package can be stored in the package and later reused. Zipper closures are mounted to the inside panels of the package and can involve an intensive assembly process. Where the zipper is mounted to the package, extra packaging film must be used. Also, it can be difficult to properly seal the package ends due to the thicker material of the zipper, thus leading to possible leaks in the package and improperly sealed package interiors. Zippers can disadvantageously limit access to the product because the size of the opening to the package interior becomes restricted due to the zipper requiring more of the side edge material around the opening to seal the zipper to the bag.

Other reclosable systems may utilize an adhesive to which a flap of the bag layer folds down over the top opening of the package and attaches to an adhesive strip. This has been incorporated with the peelable fin seal, described above, such that one of the layers of the fin seal is longer in length than the other, thus creating a foldover flap, as described in PCT Publication No. WO 01/10736 published Feb. 15, 2001. This foldover flap folds down over the opening and attaches to the adhesive. Another example of a reclosable system utilizing adhesive is a package that has a tear off feature, where a single web layer is folded at the top of the package to create two panels with a fold seam at the top having score lines that are at different heights, as described in PCT Publication No. WO 2005/005275 published Jan. 20, 2005. When the top folded layer is torn off at the score lines it tears in a non-linear manner, thus opening the package and creating two flaps of differing lengths where one is longer than the other and can be used as a foldover flap. This foldover flap is used as a reclosure by folding it over the top opening and securing it to an adhesive on the package, similar to the package described above. This reclosure system requires that the package material be a single web and that the fold be located at the top seam, which is torn off at the score lines when the package is opened.

### SUMMARY

A reclosable, flexible package for storing food products, and methods of manufacture of the package, are disclosed herein. The package comprises a pair of opposing panels connected via a bottom seal and each having a flange opposite the bottom seal, and a pair of end seals formed between the opposing panels and intersecting the bottom seal. A pleat is located in one of the panels opposite the bottom seal, which is openable to permit initial access to the interior of the package. A flange seal is formed between the flanges and is spaced from the pleat, with one of the flanges extending beyond the flange seal and forming a reclosure flap. The reclosure flap is removably secured to one of the panels by an adhesion surface that is provided on either a panel or the reclosure flap, to cover the opening in the package. In addition, the pleat includes a tear strip which is removable to create an opening in the package.

In another aspect, the package comprises a top seal, which is the flange seal formed between the flanges and where the flange seal is positioned at an outer edge of the flanges. The flanges contain tear lines, with one flange having a substantially linear tear line and the other a non-linear tear line. The tear lines are both positioned between the bottom seal and the top seal, and extending between the pair of side seals, with the non-linear tear line having an end portion adjacent each of the side seals and a central portion spaced further from the bottom seal of the package than the end portion. The reclosure flap is formed in the flange or panel containing the non-linear tear line after the top seal is torn off of the package along the linear and non-linear tear lines to gain initial access to the interior of the package, and thus creating the opening. Additionally, the adhesion surface used to secure the reclosure flap to a panel of the package can be covered by a temporary tape cover that is removable after the first use of the package. Once the tape cover is removed it exposes the adhesion surface and allows attachment of the reclosure flap to the front panel.

In still another aspect, the package is convertible between an unopened configuration and a reclosed configuration, where a pleat is located in one of the panels opposite the bottom seal in the unopened configuration, and the pleat is opened in the reclosed configuration and the opened pleat permits access to the interior of the package. In the unopened configuration the flange seal between the flanges is spaced from the pleat. A reclosure flap is formed by at least one of the flanges extending beyond the flange seal.

### BRIEF DESCRIPTION OF THE DRAWINGS

FIG. 1 is a perspective view of a reclosable package prior to use;

FIG. 2 is a perspective view of the reclosable package of FIG. 1 after the flange is opened;

FIG. 3 is a perspective view of the reclosable package of FIG. 1 after opening the package and after removal of the tear strip;

FIG. 4 is a perspective view of the reclosable package of FIG. 1 after the package is reclosed;

FIG. 5 is a side cross-sectional view of the reclosable package of FIG. 1;

FIG. 6 is a side cross-sectional view of the reclosable package of FIG. 2;

FIG. 7 is a side cross-sectional view of the reclosable package of FIG. 3;

FIG. 8 is a side cross-sectional view of the reclosable package of FIG. 4;

FIG. 9 is a perspective view of another embodiment of a reclosable package prior to use;

FIG. 10 is a perspective view of the reclosable package of FIG. 9 after the flange is unfolded;

FIG. 11 is a perspective view of the reclosable package of FIG. 9 after opening the package and after removal of the tear strip;

FIG. 12 is a perspective view of the reclosable package of FIG. 9 after the package is reclosed;

FIG. 13 is a side cross-sectional view of the reclosable package of FIG. 9;

FIG. 14 is a side cross-sectional view of the reclosable package of FIG. 10;

FIG. 15 is a side cross-sectional view of the reclosable package of FIG. 11;

FIG. 16 is a side cross-sectional view of the reclosable package of FIG. 12;

FIG. 17 is a perspective view of a process line used in the manufacture of reclosable packages;

FIG. 18 is a side cross-sectional view of the process line of FIG. 17 detailing an optional tape and/or zipper application station;

FIG. 19 is a schematic view showing a fin sealer station comprising heaters;

FIG. 20 is a schematic view showing another section of a fin sealer station of comprising rollers;

FIG. 21 is a plan view of a web material used in another embodiment of a reclosable package;

FIG. 22 is a front plan view of the reclosable package made with the web material of FIG. 21;

FIG. 23 is a perspective view of the reclosable package of FIG. 22 prior to use;

FIG. 24 is a perspective view of the reclosable package of FIG. 22 while opening the package;

FIG. 25 is a perspective view of the reclosable package of FIG. 22 after opening the package;

FIG. 26 is a side cross-sectional view of the reclosable package of FIG. 23;

FIG. 27 is a side cross-sectional view of the reclosable package of FIG. 23 after unfolding the reclosure flap but before opening;

FIG. 28 is a side cross-sectional view of the reclosable package of FIG. 25; and

FIG. 29 is a side cross-sectional view of the reclosable package of FIG. 25 after the package is reclosed.

### DETAILED DESCRIPTION OF THE DRAWINGS

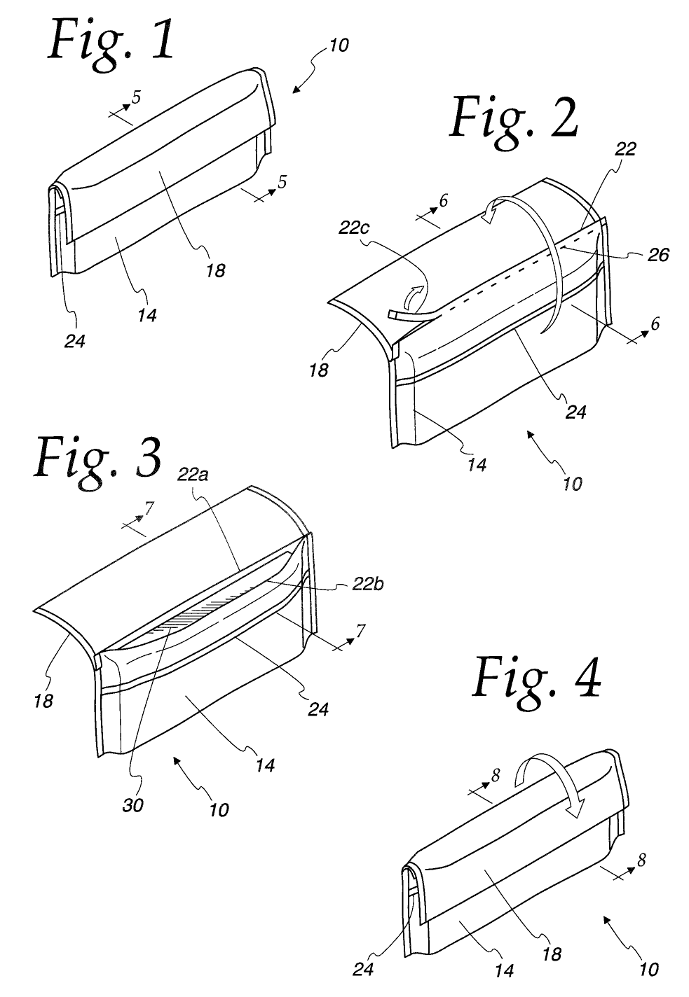

A reclosable easy-open flexible package, and in particular a reclosable easy-open flexible package used for packaging cheese, meats, candy and other solid foods, and methods of manufacture, are disclosed herein and illustrated in FIGS. 1-29. The reclosable, flexible package has an easy-open tear strip for gaining access to the interior of the package, with an adhesive surface provided for resealing a reclosable flap to the package.

The reclosable, flexible package may be made from a single web of film or from two layers sealed together; typically a single web of film is used and may be wrapped around the food product to be packaged where the side edges of the film are brought together and sealed at the top end of the package. After the side edges are brought together and sealed to each other, an excess flap of film may remain on the package. This flap of film, or fin, may preferably be located on the top of the package and instead of running along the center length of the package, the fin may run along the top length of the package along a lengthwise edge of the package. The fin, or the excess flap of film, may be sealed together with a durable seal, such as a heat seal. A durable fin seal may be desired for hermetically sealing the package and usually the package will not be separated at the fin seal.

Additionally, the two flaps of film may be of different lengths, such that one flap is longer than the other. This may be done by offsetting the edges of the web slightly when the edges are brought together after being wrapped around the product where the outer edge of one extends beyond the outer edge of the other, instead of matching them up exactly. The fin seal is not positioned at the ends of both edges of film but rather at the edge of one and at an inner point of the other (i.e., spaced some distance away from the edge).

One of the web panels may contain a tear strip feature that allows for entry into the package interior. As the tear strip is removed, it creates an opening in the package. The fin seal between the two fin flaps is not disturbed during the opening of the package and remains intact The longer portion of the fin flap may be used as a reclosable flap, as will be discussed in detail herein, to cover the package opening and may be held in place by an adhesive surface.

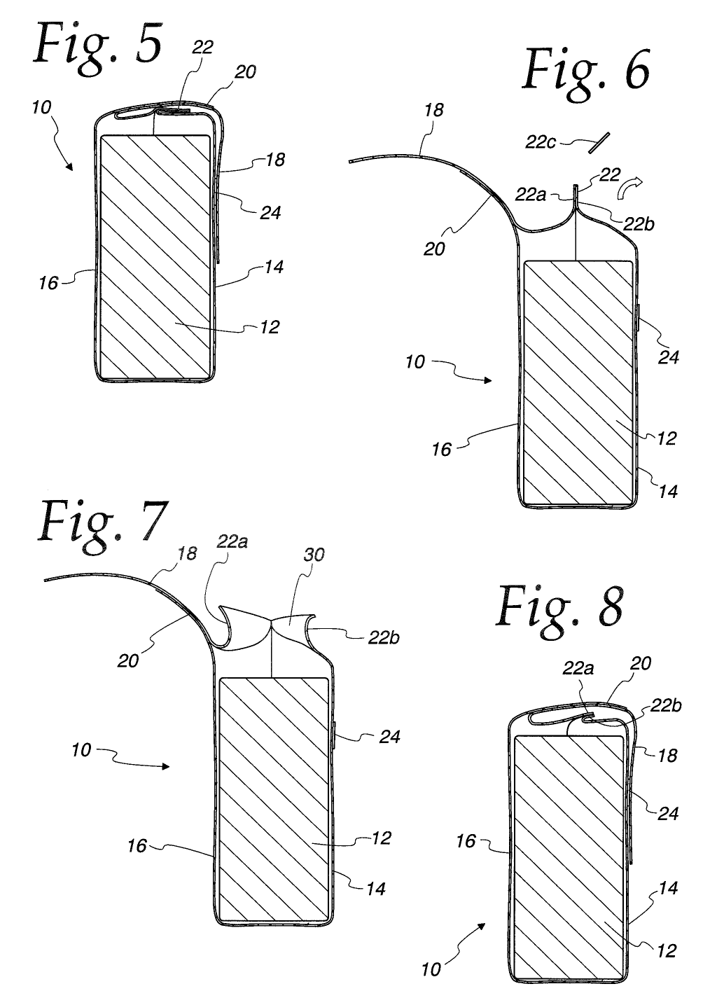

One embodiment, as shown in FIGS. 1-8, comprises a flexible package 10 with a pair of opposing panels, a front wall 14 and a back wall 16. The opposing panels 14 and 16 may be connected via a bottom seal and/or a fold made in the web of film at a bottom end after it is wrapped around the product 12. Opposite the bottom seal or fold may be a pair of flanges 18 and 20, each located in one of the opposing panels 14 and 16. A pair of side seals, or end seals, may also be formed between the opposing panels 14 and 16 where each side seal intersects the bottom seal to bound at least a portion of a package interior. The front wall 14 and the back wall 16 may each have outer edges that may be brought together and sealed, such as with a flange or fin seal, to form the flanges 18 and 20; the front wall flange 18 may be a continuation of the front wall 14 and the back wall flange 20 may be a continuation of the back wall 16. The fin, or flanges 18 and 20, may be folded over the top portion of the package 10 and pre-bonded to the package 10 prior to initial use, as shown in FIGS. 1 and 5. The front wall flange 18 may be folded over the top portion of the package 10 to cover a pleat, or front wall pinch seal 22, that may contain a tear strip 22c for opening the package 10. The front wall flange 18 may be secured in place by an adhesive strip 24 until its initial use. The adhesive strip 24 may be positioned on either a wall panel or a reclosure flap, or both.

As seen in FIGS. 5-8, the front wall flange 18 may extend beyond the back wall flange 20, and in effect beyond the flange seal, or fin seal, thus creating a reclosure flap using the front wall flange 18. The intersection of the back wall flange 20 and the front wall flange 18 at the fin seal may be along the same plane as the back wall 16. Therefore, the front wall 14 extends over the top portion of the package 10 until it intersects with the back wall flange 20 and is sealed to the back wall flange 20 via the fin seal in the plane of the back wall 16, thus forming the front wall flange 18.

A front wall pinch seal 22, or pleat, may be positioned at about the center of the top portion of the package 10 or any other convenient location, and may function as a tear strip 22c used to open the package 10, as seen in FIGS. 2 and 6. The front wall pinch seal 22 may typically be a part of the front wall 14 and may be positioned on the top portion of the package 10 spaced from the fin seal that joins the flanges 18 and 20 together. The front wall pinch seal 22 may have a front panel 22b and a back panel 22a, with a center tear line 26 positioned at the middle of the front wall pinch seal 22 and indicating the tear area where the front panel 22b may be separated from the back panel 22a. A tear strip 22c along the center of the front wall pinch seal 22, and between the front panel 22b and back panel 22a, may be removed by pulling it across the top of the front wall pinch seal 22 along the tear line 26, see FIG. 2. The tear strip 22c may be spaced at least about 0.25 inches above the food product 12 inside, and preferably is spaced from about 0.25 inches to about 1.50 inches above the food product 12. As the tear strip 22c is pulled across the tear line 26, it separates the back panel 22a of the pinch seal from the front panel 22b of the pinch seal and creates an opening 30 in the top of the package 10 to gain initial access to the interior of the package 10. The opening 30 may be bound by a perimeter formed by the outer edges of the back panel 22a and the front panel 22b. Also, after the tear strip 22c is opened, the front wall flange 18 is typically only connected to the package at the fin seal; removing the tear strip separates the front wall flange 18 from the front wall 14 portion of the package 10.

An adhesion surface may be provided on one of the opposing wall panels 14 and 16 or on the reclosure flap or both, to removably secure the reclosure flap to a panel. The adhesion surface may comprise an adhesive strip 24 located along the front wall 14 of the package 10, and preferably oriented in a horizontal line across the front wall 14, but may be in any convenient orientation. The adhesive strip 24 may comprise double-faced tape where one side of the adhesive strip 24 contains a first adhesive to create a permanent attachment and the opposite side of the strip contains a second adhesive, typically for creating a removable attachment. Alternatively, an adhesive stripe may be coated onto the film, or any other similar adhesion surface may be used. The front wall flange 18 may be pre-bonded to the adhesive strip 24, as seen in FIGS. 1 and 5, prior to its initial use. Once the package 10 is to be opened, the front wall flange 18 may be removed from the adhesive strip 24 by lifting to expose the tear strip 22c and the adhesive strip 24 surface.

After opening the package 10, it may be desired to reclose the package 10 and store the food product 12 therein. This may be done by re-folding the front wall flange 18, or reclosure flap, across the top portion of the package 10 to cover the opening 30 and to secure the flap by affixing it to the adhesive strip 24 positioned along the front wall panel 14, as shown in FIGS. 4 and 8, similar to how the front wall flange 18 was pre-bonded to the adhesive strip 24 before use.

Alternatively, the opposite configuration of the flanges 18 and 20 may be applied. The back wall flange 20 may extend past the front wall flange 18 and the back wall flange 20 may serve as the reclosable flap. All of the other descriptions would remain the same, and the pinch seal would still be located in the front wall panel at the top of the package 10.

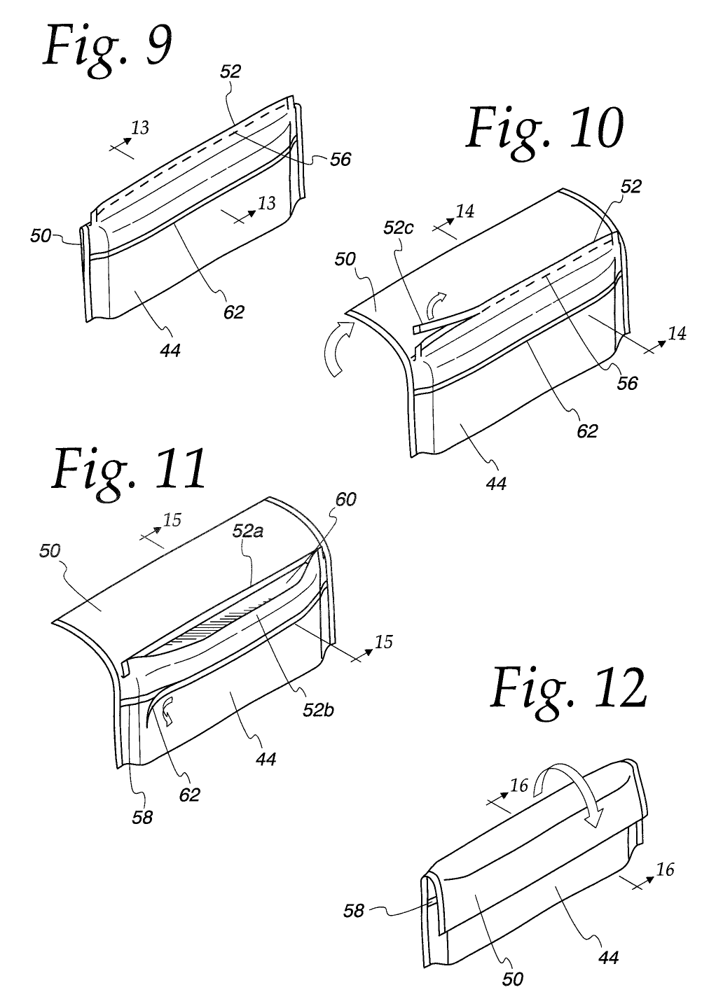

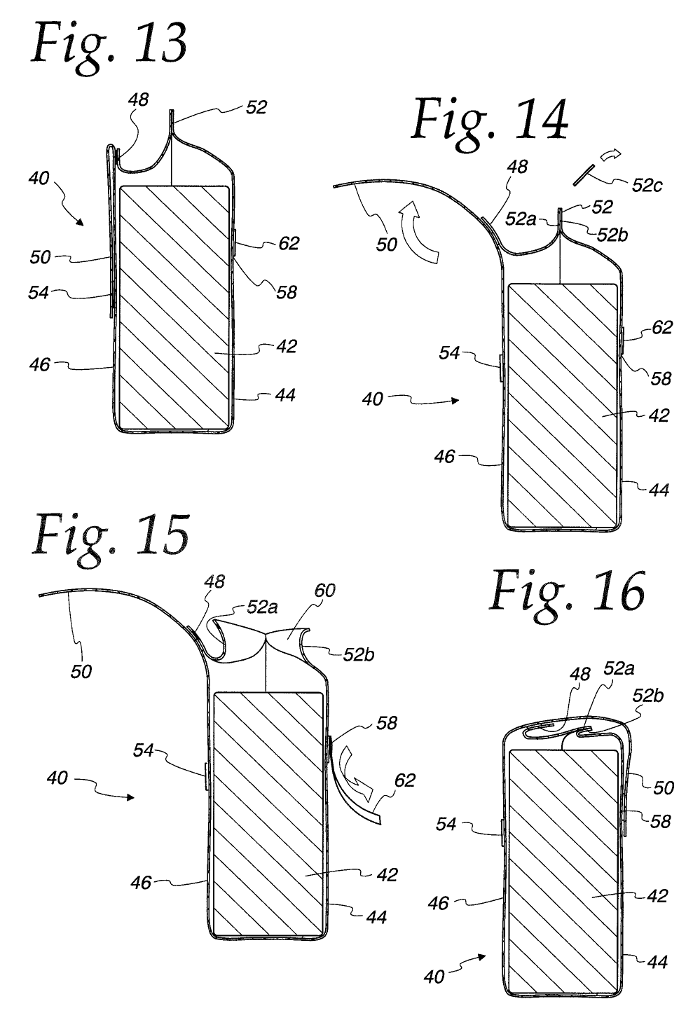

Another embodiment, as shown in FIGS. 9-16, consists of a flexible package 40, where the fin flanges 48 and 50 may be pre-bonded to the back wall 46 during storage and prior to initial use. The back wall flange 50 may be the longer of the two flanges 48 and 50 and may function as the reclosure flap; however the opposite configuration may also be possible. The back wall flange 50, or reclosure flap, may be secured in place to the back wall 46 until the first use by an adhesive patch 54 located along the back wall 46, as shown in FIGS. 9 and 13, or alternatively, on an outer side of the reclosure flap.

The adhesive patch 54 may be any convenient shape or configuration as long as it is adequate for securing the back wall flange 50 to the package 40 until initial use. In this configuration, the front wall flange 48 may be the shorter of the two flanges 48 and 50 and typically is not long enough to also fold down the back wall 46 along with the back wall flange 50. The front wall flange 46 may be sealed to the back wall flange 50 at or near the outer edge of the front wall flange 46, and the back wall flange 50 may be sealed to it at a point spaced some distance away from the outer edge of the back wall flange 50.

The front wall pinch seal 52 may be similar to the front wall pinch seal 22 of the previous embodiment. The front wall pinch seal 52, shown in FIGS. 10 and 14, may be similarly located in the top portion of the front wall panel 44, spaced from the fin seal and the edge of the front wall flange 48. The front wall pinch seal 52 also may have a back panel 52a of the pinch seal and a front panel 52b of the pinch seal with a center tear line 56 positioned at the midpoint of the two panels 52a and 52b and indicating the tear area where the front panel 52b may be separated from the back panel 52a. A tear strip 52c may be located along the center of the front wall pinch seal 52 and between the front and back panels 52a and 52b. The tear strip 52c may be removed by pulling it across the top of the front wall pinch seal 52 to create an opening 60 in the package, as shown in FIGS. 11 and 15. Similarly, the tear strip 52c may be spaced at least about 0.25 inches above the food product 42, and preferably is spaced from about 0.25 inches to about 1.50 inches above the food product 42.

To reclose the package 40, the back wall flange 50, or reclosure flap, may fold across the top portion of the package 40 to cover the opening 60, and may be secured in place to the front wall 44 by an adhesive strip 58 positioned along the front wall 44 of the package 40, or alternatively, along an inner side of the reclosure flap. The adhesive strip 58 may be either a tape or coating, as described in the previous embodiment, or any other similar adhesion surface. To keep the adhesive strip 58 intact prior to use, a temporary tape cover 62 may be placed over the adhesive strip 58 to protect the adhesive strip 58 from losing its adhesion strength prior to use. Once it is desired to reseal the package 40 after the initial opening, the tape cover 62 may be removed after the first use of the package 40 to expose the adhesive strip 58 and to allow attachment of the back wall flange 50, or reclosure flap, to the front panel 44.

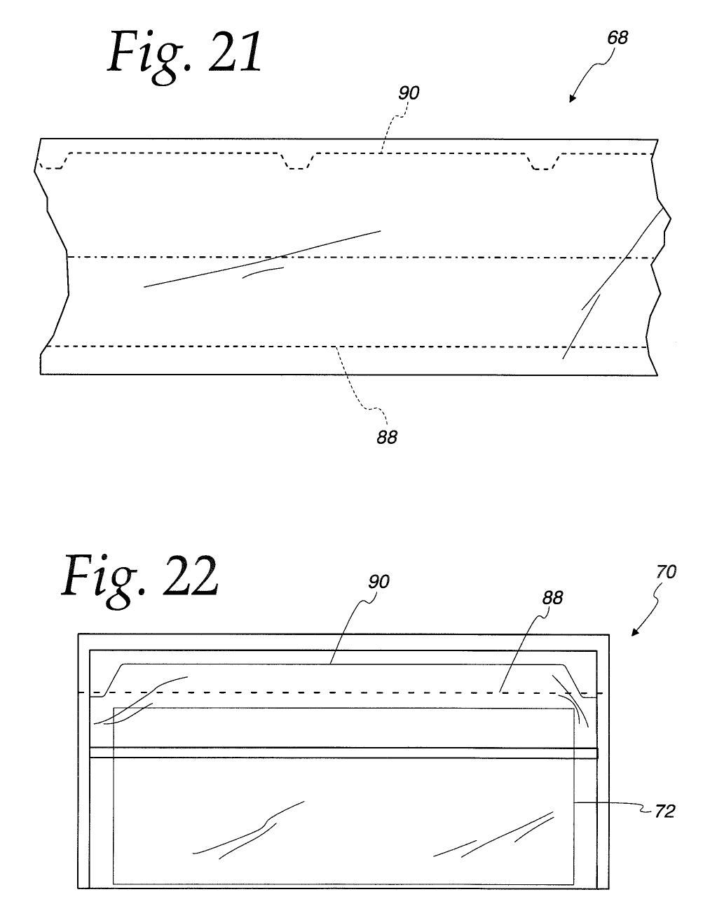

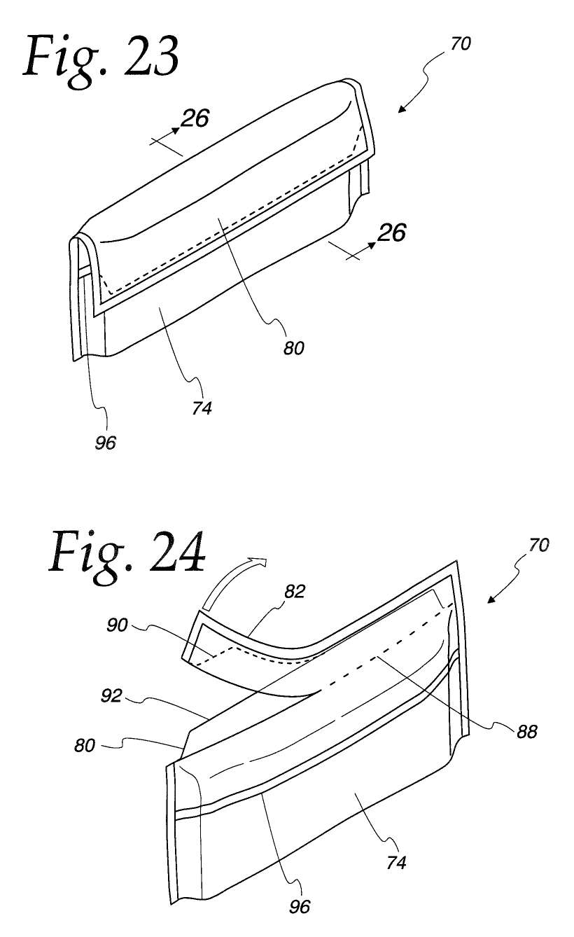

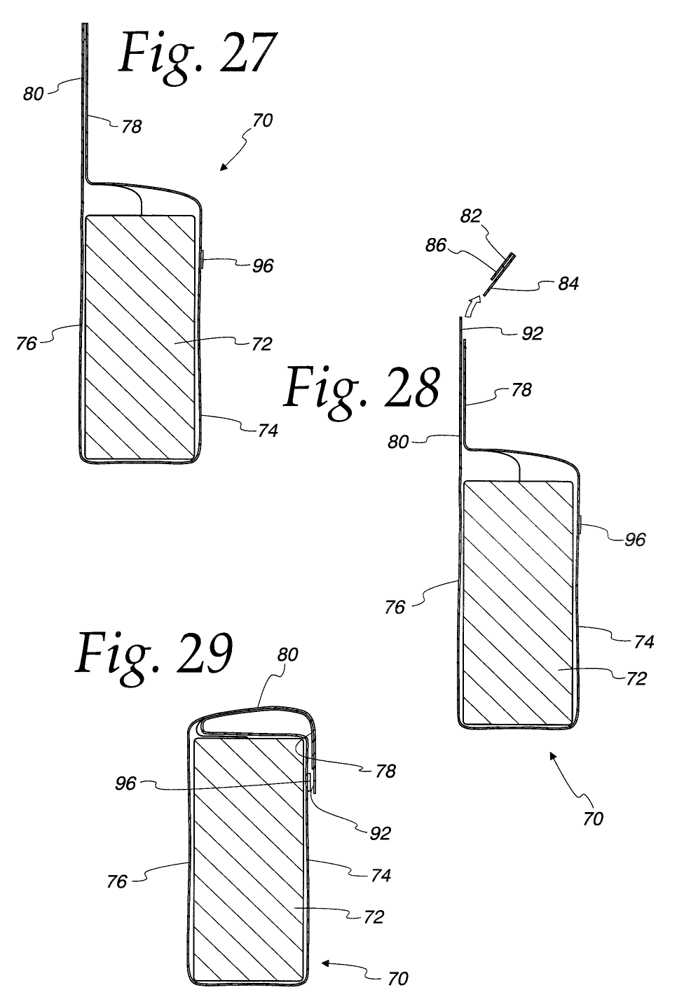

Another embodiment of a flexible package 70 is illustrated in FIGS. 21-29, and may contain front and back wall flanges 78 and 80 where each is a part of one of the pair of opposing panels 74 and 76, respectively, and may be positioned in an upright configuration where the fin seal, or top seal, may be located between the flanges 78 and 80 and extending between the pair of side walls, or the package 70 may be in a folded over configuration, as in FIGS. 23 and 26. Preferably, the flanges 78 and 80, may be folded over the top portion of the package 70 and pre-bonded to the package 70 prior to initial use, as shown in FIGS. 23 and 26. The front wall flange 78 together with the back wall flange 80 may be folded over the top portion of the package 70 to cover the top portion of the package 70 and may be secured in place by an adhesive strip 96 until its initial use. The adhesive strip 96 may be positioned on either a wall panel or a reclosure flap, or both. This design can eliminate the need for a tape cover to protect the adhesive strip 96 since the flange/reclosure flap is placed over the adhesive strip 96 before use. The front wall flange 78 and back wall flange 80 may be about equally aligned and the top seal may be positioned at an outer edge of the flanges 78 and 80, as shown in FIGS. 22 and 27. The tear strip may be incorporated into the flanges 78 and 80, at a distance below their top edges, such that when the tear strip is torn away it tears away a portion of the flanges 78 and 80 and the top seal with it to gain initial access to the interior of the package 70 and to create an opening 94. The flanges 78 and 80 each may contain a tear line across the flanges 78 and 80 in a lengthwise direction between the side walls and at a distance below the top edge, where the tear lines predetermine the tear area when opening the package 70.

The tear lines 88 and 90 along the flanges 78 and 80, respectively, may be located in different positions depending on the flange it is located on. For instance, the front tear line 88 may be located on the front wall flange 78 and may be a substantially linear tear line extending between the pair of side walls and positioned between the bottom and top seal, as shown in FIG. 22, and may be at a lower elevation than the back tear line 90. The back tear line 90 may be located on the back wall flange 80 and may be a non-linear line, or curve, as can be seen in FIG. 22 viewed from the back wall flange 80, and also extending between the pair of side seals and positioned between the bottom and top seals. The majority of the back tear line 90 is positioned at a higher elevation than the front tear line 88 such that the back tear line 90 has an end portion adjacent each of the side seals and a central portion spaced further from the bottom seal of the package than the end portions. The back tear line 90 may partially overlap the front tear line 88 at a position adjacent the side seals. The back tear line 90 begins at a position just below the front tear line 88, and may then slope upwards towards the top of the fin seal and may become linear until it reaches the opposite side seal where it may slope downward, intersecting the other side of the front tear line 88 and ending at a point just below it.

A flat film 68 used to create this type of package is shown in FIG. 21, with tear lines scored into the flat film 68 to enable a continuous packaging process. During the packaging process, the film 68 may wrap around the product such that the back tear line 90 partially overlaps the front tear line 88 as the film 68 is folded up around the product and the outer edges are aligned. The back tear line 90 is scored into the flat film 68 as a continuous line such that there is a series of peaks and valleys scored across the film 68 for packaging a series of products one after the other. Therefore, the back tear line 90 is etched into the film 68 as a series of peaks and valleys where from the midpoint of one of the valleys to the midpoint of the next defines the length of a single package 70.

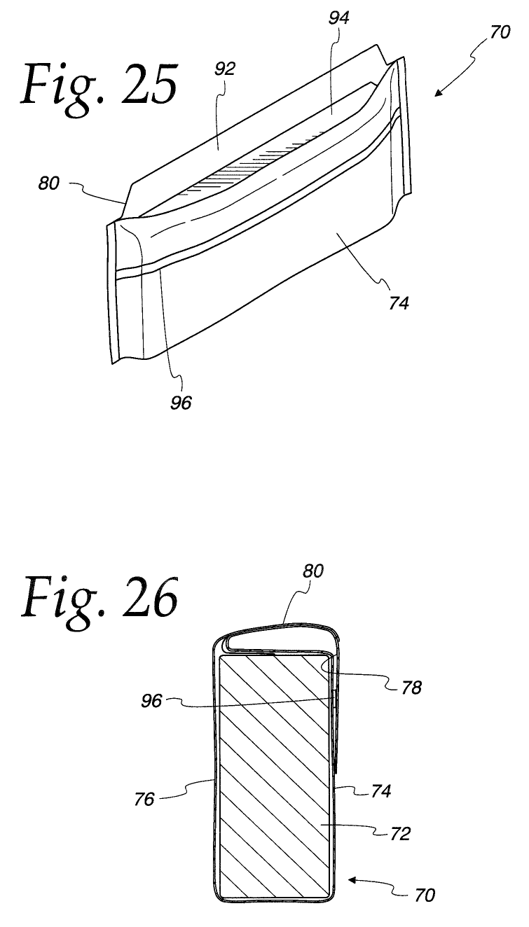

To gain access to the interior of the package 70, the user may tear along the tear lines 88 and 90 starting at an edge of the package 70 which may contain a tear notch. The tear lines 88 and 90 both may originate from this same tear notch at a tear initiation point. A removable shroud 82 containing a portion of the back wall flange 80 and a portion of the front wall flange 78 may be torn off in a predictable pattern following the tear lines 88 and 90, as shown in FIGS. 24 and 28. Once the removable shroud 82 is torn off the package 70, an opening 94 may be revealed with access provided to the interior of the flexible package 70, as shown in FIG. 25. After tearing off the removable shroud 82 the flanges 78 and 80 may be at different heights due to the different elevational placement of the tear lines 88 and 90. The back wall flange 80 may extend past the front wall flange 78 due to the way the tear lines 88 and 90 are positioned (i.e., the back wall flange 80 contains the non-linear tear line positioned at a higher elevation than the linear tear line of the front wall flange 78), thus creating a reclosure flap out of the back wall flange 80 when the removable shroud 82 is torn off. The removable shroud 82 may contain a portion of the fin seal, where the flanges 78 and 80 were sealed together, and the removable shroud 82 may have a back shroud wall 86 that may be a shorter length than a front shroud wall 84, as shown in FIG. 28.

When the package 70 is to be resealed, the back wall flange 80 may be used to cover the opening 94 by folding it across the top portion of the package 70 and over the opening 94. An adhesive strip 96 on the front wall 74 may be used to secure the back wall flange 80, or reclosure flap, to the front wall 74 upon contact, or alternatively, the adhesive strip 96 may be along an inner surface of the reclosure flap. The adhesive strip 96 may be a tape, a coating, or any other similar adhesion surface. Optionally, there may be a tape cover over the adhesive strip 96 to protect it until initial use, where the reclosure flap is not in the folded over position initially and the adhesive strip 96 is exposed, as explained in the previous embodiment.

Once the back wall flange 80 is folded down over the opening 94, it becomes the outermost top surface of the package and the front wall flange 78 is located underneath it, along the inside of the back wall flange 80 and next to the top opening 94 of the package 70, as seen in FIG. 29.

The above features may be varied slightly and still describe the same basic package. For example, where it is described above that a back wall flange is longer than a front wall flange and serves as a reclosure flap, the opposite may also be true where the front wall flange can be longer and thus serve as the reclosure flap.

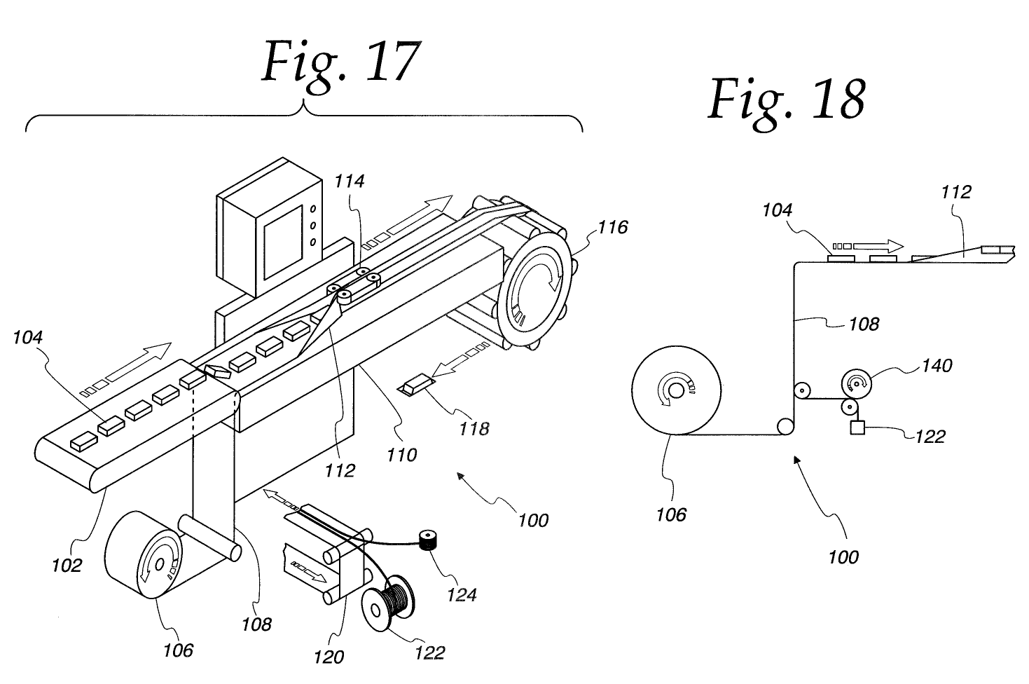

Turning to the method of manufacture, as shown in FIGS. 17-20, a process equipment line can be used for making the resealable, flexible packages discussed above. A packaging machine 100 is shown for making the resealable, flexible packages 118, as shown in FIG. 17. The equipment 100 may have an infeed conveyor 102 for transporting food 104 in a machine direction to a conveyor for a web of film 108 where it is placed on the film 108. The film 108 may be contained on a film roll 106 and as it unwinds the film 108 is carried along a conveyor that also may advance in a machine direction. The film 108 may preferably be fed from beneath the infeed conveyor 102 initially and where it joins the food product 104 it can advance in a machine direction together with the food 104. After the food 104 is conveyed onto the film 108, the two advance together in a machine direction where they pass a forming station 110, and where a forming plow 112 folds up the longitudinal edges of the film 108 thus wrapping it around the food product 104 so that the food product 104 is encompassed between the film edges. The food and folded up film continue to advance in a machine direction between rollers and/or heaters located within the fin sealer section 114 of the machine 100, which further aids in the folding of the edges of film 108. The loose ends, or opposing longitudinal edge portions, of the film 108 that were folded up may form a fin, which is sealed by the fin sealer section 114 and then continues to advance in a machine direction to an end cutter and transverse sealer section 116. At the end cutter and transverse sealer section 116, a pair of transverse seals, such as end seals, can be made and the packages can be cut apart from the remainder of the web to form the final sealed package 118. If the fin seal is to be provided in a folded down orientation, the newly formed fin seal may be folded down to cover an adhesive on the package as it enters the transverse (i.e., end) sealer section 116.

An optional conveyor 120, shown at FIG. 17, may be used to incorporate a zipper system 122 and/or a tear strip 124 with the web of film 108 prior to advancing through the packaging machine 100. The film 108 may be diverted to the zipper/tear strip station 120 as it unwinds from the film roll 106 and may pass through the equipment 120 to apply the zipper and/or tear strip to the film 108. After sealing the zipper and/or tear strip to the film 108, the film 108 is redirected back into the packaging machine 100.

Another embodiment of the packaging machine 100 may include the addition of an adhesive reclose system, as shown in FIG. 18. Here the adhesive tape is applied to the film to be used with the reclose feature. As the film 108 unwinds from the film roll 106 it may advance past a tape roll 140 that may apply a double-faced tape to the outside of the film 108. A similar system may also be used to apply the tear strip if desired. It may also be possible to use pre-coated film that already contains an adhesive.

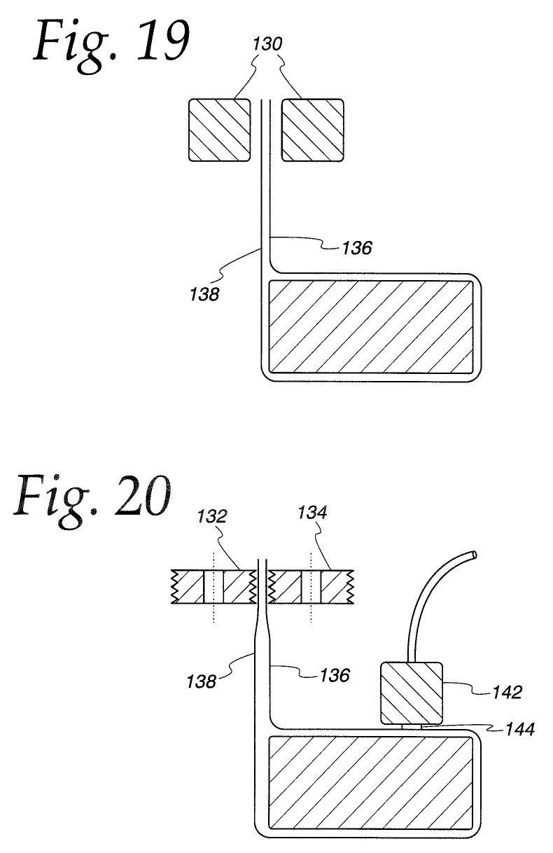

Alternatively, the adhesive strip may be coated onto the package after it passes through the fin sealer section 114, as shown in FIGS. 19 and 20. After the film 108 passes by the forming plow 112 it enters the fin sealer section 114 where the fins or flanges are first sealed and then may subsequently receive an application of adhesive. Forming the fin seal comprises two steps, a heat step followed by a seal step. The first step, the heat step, is shown in FIG. 19 where the film that is wrapped around the food product passes between two radiant heaters 130. The fin seal may be offset from the centerline of the package such that the fin seal and fin flanges are positioned at an outer, or peripheral, edge of the package to form an offset fin flange. The offset fin is positioned at the outer edge after it is folded up around the food product 104 and after passing the forming plow 112. As the film passes between the radiant heaters 130, the heaters 130 heat the film so that it becomes hot enough to bond together. The heaters 130 further do not touch the film as it passes between them, but are positioned close enough to the film that the heaters 130 provide sufficient heat to the film material without touching it. After passing between the radiant heaters 130, the second step comprises passing the film between two crimping wheels 132 and 134, or rollers, positioned one on each side of the film and provided for sealing the two heated sections of film together by applying pressure to the fin seal flanges so that they are brought into contact to form a fin seal. After passing between the wheels 132 and 134, the partially formed package may be coated with an adhesive 144 using a slot die 142. The fin seal is folded over and onto the adhesive section at the end cutter and transverse sealer section 116, such that the adhesive is not exposed once the package is complete. Although specific examples of methods of manufacturing packages are discussed, other methods that result in the disclosed packages may be used.

From the foregoing, it will be appreciated a resealable, flexible package is provided that allows for storing food inside and further provides an easy open package with a reclosable flap that affixes to an adhesive surface of the package to provide for storing of the food product therein. However, the disclosure is not limited to the aspects and embodiments described hereinabove, or to any particular embodiments. Various modifications to the resealable, flexible package and methods of assembling can result in substantially the same package.

What is claimed is:

1. A reclosable, flexible package for a food product, the package comprising:
a pair of opposing panels connected via a bottom seal, the pair of opposing panels each having a flange opposite the bottom seal;
a pair of end seals formed between the opposing panels, each of the end seals intersecting the bottom seal to bound at least a portion of a package interior;
a pleat in one of the panels opposite the bottom seal, the pleat being openable to permit initial access to the interior of the package;
a flange seal between the flanges of the pair of opposing panels and spaced from the pleat, at least one of the flanges extending beyond the flange seal to form a reclosure flap; and
an adhesion surface provided on one of the panels and the reclosure flap, the adhesion surface adapted to removably secure the reclosure flap to the one of the panels.

2. The package according to claim 1, wherein the pleat includes a tear strip, the tear strip being removable to gain initial access to the interior of the package and to create an opening in the package.

3. The package according to claim 1, wherein the flange seal is an offset fin along an outer edge of the package.

4. The package according to claim 1, wherein the adhesion surface is an adhesive strip on one of a front panel and the flap.

5. The package according to claim 4, wherein the strip is of a double-faced tape, wherein a first adhesive is on one side of the strip to create a permanent attachment and a second adhesive is on an opposite side of the strip.

6. The package according to claim 4, wherein an adhesive patch is located on one of a back panel and an outer side of the reclosure flap to secure the flap to the back panel.

7. The package according to claim 6, wherein the adhesive strip is covered by a temporary tape cover removable after a first use of the package to expose the adhesive strip and to allow attachment of the reclosure flap to the front panel.

8. The package according to claim 4, wherein the flanges are folded over the pleat and across a top portion of the package and secured to the adhesive strip positioned along the front panel.

9. The package according to claim 2, wherein the tear strip is spaced at least about 0.25 inch above the food product.

10. The package according to claim 9, wherein the tear strip is spaced from about 0.25 to about 1.50 inches above the food product.

11. The package according to claim 4, wherein the opening is covered by folding the reclosure flap over a top portion of the package and secured there by affixing the reclosure flap to the adhesive strip positioned along the front panel.

12. A reclosable, flexible package for a food product, the package comprising:
a pair of opposing panels connected via a bottom seal, a top seal and a pair of side seals bounding a package interior, the top seal having a flange seal between two flanges that are each a part of one of the pair of opposing panels opposite the bottom seals and where the flange seal is positioned at an outer edge of the flanges;
a substantially linear tear line in one of the pair of opposing panels positioned between the bottom seal and the top seal and extending between the pair of side seals;
a non-linear tear line in the other of the pair of opposing panels extending between the pair of side seals, the non-linear tear line having an end portion adjacent each of the side seals and a central portion spaced further from the bottom seal of the package than the end portions;
a reclosure flap formed in one of the panels containing the non-linear tear line; and
an adhesion surface provided on one of the panels and the reclosure flap, the adhesion surface adapted to removably secure the reclosure flap to the one of the panels.

13. The package according to claim 12, wherein the top seal can be torn off of the package along the linear and non-linear tear lines to gain initial access to an interior of the package and to create an opening.

14. The package according to claim 12, wherein the flange seal is an offset fin along an outer edge of the package.

15. The package according to claim 13, wherein a portion of the flanges is removed when the top seal is torn off.

16. The package according to claim 12, wherein the adhesion surface is an adhesive strip on one of a front panel and the flap.

17. The package according to claim 16, wherein the strip is of a double-faced tape, wherein a first adhesive is on one side of the strip to create a permanent attachment and a second adhesive is on an opposite side of the strip.

18. The package according to claim 13, wherein the opening is covered by folding the reclosure flap over a top portion of the package and secured there by affixing the reclosure flap to the adhesive strip positioned along the front panel.

19. A reclosable, flexible package for a food product convertible between an unopened configuration and a reclosed configuration, the package comprising:
a pair of opposing panels connected via a bottom seal, the pair of opposing panels each having a flange opposite the bottom seal;
a pair of end seals formed between the opposing panels, each of the end seals intersecting the bottom seal to bound at least a portion of a package interior;
a pleat in one of the panels opposite the bottom seal when the package is in the unopened configuration, the pleat being opened to permit access to the interior of the package when the package is in the reclosed configuration;
a flange seal between the flanges of the pair of opposing panels and spaced from the pleat when the package is in the unopened configuration, at least one of the flanges extending beyond the flange seal to form a reclosure flap; and
an adhesion surface provided on one of the panels and the reclosure flap, the adhesion surface adapted to removably attach the reclosure flap to the one of the panels.

20. A method of forming a reclosable, flexible package for a food product comprising:
directing a web of film in a machine direction;
placing a food product onto the web of film;
folding the web of film around the food product as the web of film passes over a forming tool;
sealing opposing longitudinal edge portions of the web of film to form an offset fin seal;
applying an adhesive to a panel of the package;
folding the fin seal against the adhesive to attach the fin seal to the panel of the package;
forming a pair of transverse seals to enclose the food product between the transverse seals and the fin seal; and separating the package from the remainder of the web of film.
